(19) United States
(12) Patent Application Publication
(10) Pub. No.: US 2004/0115551 A1
(43) Pub. Date: Jun. 17, 2004

(54) Toner for developing electrostatic latent image

(75) Inventors: Tsunemi Sugiyama, Numazu-shi (JP); Hiroshi Yamashita, Numazu-shi (JP); Yohichiroh Watanabe, Fuji-shi (JP); Takuya Saito, Numazu-shi (JP); Takeshi Takada, Numazu-shi (JP); Masanori Suzuki, Shizuoka-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: RICOH COMPANY, LTD., Tokyo (JP)

(21) Appl. No.: 10/674,358

(22) Filed: Oct. 1, 2003

(30) Foreign Application Priority Data
Oct. 1, 2002 (JP) 2002-289090

(51) Int. Cl. G03G 9/087

(52) U.S. Cl. 430/109.4; 430/124; 430/137.1

(57) ABSTRACT

An improved toner comprises a binder resin comprising a urea-modified polyester resin; a colorant master batch comprising a colorant; a resin; and a pigment dispersant. The toner is prepared by a method comprising dissolving or dispersing toner compositions including a modified polyester resin capable of forming the urea-modified polyester resin and the colorant master batch in an organic solvent to provide a liquid; dispersing the liquid in an aqueous medium including resin fine particles while reacting the modified polyester resin with at least one of a crosslinker and an elongation agent to provide particles; and washing the particles after removing the organic solvent therefrom.

### BACKGROUND OF THE INVENTION

1. Field of the Invention

The present invention relates to a toner for developing an electrostatic latent image, more particularly to a toner for developing an electrostatic latent image formed on a photoreceptor, and a process cartridge comprising the toner.

2. Discussion of the Background

An electrophotographic apparatus or an electrostatic recording apparatus adheres a toner onto an electrostatic latent image formed on a photoreceptor, transfers the toner image onto a transfer material and fixes the toner image on the transfer material with a heat. A full color image is typically formed by using a black, a yellow, a magenta and a cyan color toner. Each color toner is developed and overlapped on a transfer material, and heated and fixed at the same time to form a full color image on the transfer material.

However, users who are used to printed images are not satisfied with images produced by full-color copiers, and demand higher definition and higher resolution images. Toners having a small particle diameter and a narrow particle diameter distribution are known.

A conventional toner is prepared by melting, mixing and uniformly dispersing a colorant, a charge controlling agent and an offset inhibitor in a thermoplastic resin, and by pulverizing and classifying the mixture. Such methods of producing a toner tend to produce toners having a wide particle diameter distribution range. For example, fine particles having a diameter of not greater than 5 μm and coarse particles having a diameter of not less than 20 μm have to be removed by classifying, which has the drawback of producing quite low yields. Particularly, in preparing a color toner, it is difficult to uniformly disperse a colorant and a charge controlling agent in a thermoplastic resin. An uneven dispersion of the colorant and charge controlling agent has an adverse effect on fluidity, developability, durability and the ability of the resulting toner to provide a quality image.

Recently, to solve the problems of pulverizing methods, a wet granulating method for producing toner has been suggested and practiced. The wet granulating method can eliminate the need for a conventional pulverizing process and a kneading process and contributes to cost reductions by saving energy and production time, and by improving process yield. Furthermore, the wet granulating method produces a toner having a sharp particle diameter distribution as well as a small particle diameter, which contributes to the higher quality image produced by the toner. Known methods include suspension polymerization methods, emulsion polymerization methods and polymer suspension methods.

The suspension polymerization method is a method of producing toner particles by suspending and polymerizing a polymeric monomer, a polymerization initiator and toner components such as colorants in an aqueous medium including a dispersant. The problem with this method is that a polyester resin which is preferably used for a full color toner cannot be used because the binder resin is limited to a styrene-acrylic resin. In addition, it is difficult to produce a toner having two peaks in its molecular weight distribution to have both low-temperature fixability and hot offset resistance with sensitive control. Also, the resulting toner has poor cleanability because it has a spherical shape.

The emulsion polymerization method is a method of producing a toner by emulsifying and polymerizing a polymerizing monomer and a polymerization initiator in water including a surfactant to form fine particles, and by agglomerating and fusion bonding the fine particles. This method can produce an amorphous particulate toner, which has better cleanability than a suspension polymerized toner. However, it is as difficult to use a polyester resin and control molecular weight in this method as it is in the suspension polymerization method. In addition, a large amount of the surfactant remains not only on the surface of the particles, but also inside the particles, even after they have been washed with water. Therefore, the resulting toner does not become stably charged depending on the environment, and has a wide charge amount distribution, and produces images with background fouling. Furthermore, the remaining surfactant contaminates the photoreceptor, charging roller, and developing roller, resulting in deterioration of the original chargeability of these devices.

A polymer suspension method is a method of granulating a polymer in water without a polymerization reaction, in which the binder resin polymer and toner components are dispersed and dissolved in a volatile solvent such as organic solvents having a low boiling point. The mixture is emulsified in an aqueous medium including a dispersant, the emulsified mixture is distilled and the volatile solvent is removed. A polyester resin can be used in this method. However, a crosslinked polymer resin cannot be used because the method includes a step of dispersing or dissolving a toner component in a solvent, and therefore this method cannot sufficiently control the fixability of the resulting toner.

To ensure that the full color images produced by an electrophotographic image forming method have as high a quality as that of printed images, each color toner needs to have a wide color reproducibility. To achieve this without encountering problems, a colorant having good transparency, light resistance and heat resistance is uniformly dispersed in a toner.

However, it is difficult to uniformly and finely disperse a colorant by the above-mentioned wet granulating method because the wet granulating method does not have a step for uniformly mixing toner materials with a strong shearing force in a medium having a high viscosity, as the kneading and pulverizing method does. In addition, colorant particles are not stably dispersed in a liquid even when uniformly dispersed in the initial stage of the granulating process, and the colorant particles tend to agglomerate again and be omnipresent in the interface between a toner grease spot and water. When the colorant becomes largely agglomerated, the color reproducibility and image density largely deteriorate. When the colorant is omnipresent in an interface between a toner grease spot and water, the resulting toner does not have stable chargeability.

Japanese Laid-Open Patent Publication No. 11-231572 discloses a toner having a colorant dispersed by a synergist and a polymer dispersant, in which a synergist which is a colorant derivative is included to increase the interaction between the colorant and polymer dispersant. Therefore, the dispersibility of the colorant can be improved, but a colorant in a liquid cannot be dispersed sufficiently.

For these reasons, there is a need for a toner for developing an electrostatic latent image which does not require the classifying process needed for a conventional pulverized toner, and which has good cleanability, a small particle diameter, a narrow particle diameter distribution, and is stably charged for a long time. These properties largely contribute to providing high quality images having high resolution and good tone reproducibility, high colorability, high image density, high chromaticness and transparency, and good light resistance without fading.

### SUMMARY OF THE INVENTION

Accordingly, an object of the present invention is to provide a toner for developing an electrostatic latent image which does not require the classifying process needed for a conventional pulverized toner, has good cleanability, a small particle diameter, a narrow particle diameter distribution, and is stably charged for a long time. These properties largely contributing to high quality images having high resolution and good tone reproducibility, high colorability, high image density, high chromaticness and transparency, and good light resistance without fading.

Briefly this object and other objects of the present invention as hereinafter will become more readily apparent can be attained by a toner comprising: a binder resin which comprises a urea-modified polyester resin; a colorant master batch comprising a colorant; a resin; and a pigment dispersant. The toner is prepared by a method comprising: dissolving or dispersing toner compositions comprising a modified polyester resin capable of being the urea-modified polyester resin and a colorant master batch in an organic solvent, thereby producing a liquid; dispersing the liquid in an aqueous medium comprising resin fine particles, while reacting the modified polyester resin with at least one of a crosslinker and an elongation agent to prepare particles; and washing the particles after removing the organic solvent therefrom.

Another object of the present invention is to provide a process cartridge comprising the toner of the present invention.

### BRIEF DESCRIPTION OF THE DRAWING

FIG. 1 is a schematic view illustrating an embodiment of the process cartridge of the present invention.

### DETAILED DESCRIPTION OF THE INVENTION

Generally, the present invention provides a toner for developing an electrostatic latent image, which does not require the classifying process needed for a conventional pulverized toner, and which has good cleanability, a small particle diameter, a narrow particle diameter distribution, and is stably charged for a long time. These properties largely contribute to providing high quality images having high resolution and good tone reproducibility, high colorability, high image density, high chromaticness and transparency, good light resistance without fading.

The present inventors have developed a method of producing a toner which takes advantage of the benefits of the wet granulating method, and yet solves the conventional problems. The method of the present invention for producing a toner comprises dissolving or dispersing toner compositions comprising a modified polyester resin capable of forming urea groups in an organic solvent; reacting the dissolved or dispersed toner compositions with a crosslinker and/or an elongation agent in an aqueous medium comprising resin particles; and washing the reacted toner compositions to removed the solvent therefrom.

The present invention has the advantages of being capable of producing a toner having a small particle diameter and a narrow particle diameter distribution which are features of a conventional toner produced by the wet granulating method, using a polyester resin, easily controlling molecular weight by combining (elongating) the polyester resin with a polyaddition reaction in the process of granulating, crosslinking, increasing the dispersibility of a pigment which easily adheres to a urea combination (which is a polar group on the polyester chain) and controlling the shape of the toner particles.

In the present invention, a polyester prepolymer (A) having an isocyanate group is preferably used as the modified polyester resin capable of forming urea groups. Specific examples of the prepolymer (A) having an isocyanate group include a polymer formed from the reaction between polyester having an active hydrogen atom group formed by the polycondensation of a polyol (1) a polycarboxylic acid (2), and polyisocyanate (3). Specific examples of groups having an active hydrogen atom include a hydroxyl group (an alcoholic hydroxyl group and a phenolic hydroxyl group), an amino group, a carboxyl group, a mercapto group, etc. Preferably, the active hydrogen atom group is an alcoholic hydroxyl group.

A diol (1-1) and polyol having 3 valences or more (1-2) can be used as the polyol (1), and diol (1-1) alone or a mixture of diol (1-1) and a small amount of polyol (1-2) are preferably used. Specific examples of the diol (1-1) include alkylene glycols such as ethylene glycol, 1,2-propylene glycol, 1,3-propylene glycol, 1,4-butanediol, and 1,6-hexanediol; alkylene ether glycols such as diethylene glycol, triethylene glycol, dipropylene glycol, polyethylene glycol, polypropylene glycol and polytetramethylene ether glycol; alicyclic diols such as 1,4-cyclohexanedimethanol and hydrogenated bisphenol A; bisphenols such as bisphenol A, bisphenol F and bisphenol S; adducts of the above-mentioned alicyclic diols with an alkylene oxide such as ethylene oxide, propylene oxide and butylene oxide; and adducts of the above-mentioned bisphenols with an alkylene oxide such as ethylene oxide, propylene oxide and butylene oxide. Preferably, the polyol (1) is selected from an alkylene glycol having 2 to 12 carbon atoms and adducts of bisphenol with an alkylene oxide. More preferably, the polyol (1) is a mixture thereof. Specific examples of the polyol having 3 valences or more (1-2) include multivalent aliphatic alcohols having 3 to 8 or more valences such as glycerin, trimethylolethane, trimethylolpropane, pentaerythritol and sorbitol; phenols having 3 or more valences such as trisphenol PA, phenolnovolak, cresolnovolak; and adducts of the above-mentioned polyphenol having 3 or more valences with an alkylene oxide.

A dicarboxylic acid (2-1) and a polycarboxylic acid having 3 or more valences (2-2) can be used as the polycarboxylic acid (2). Dicarboxylic acid (2-1) alone, or a mixture of (2-1) and a small amount of (2-2) are preferred. Specific examples of the dicarboxylic acid (2-1) include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalene dicarboxylic acid. In particular, alkenylene dicarboxylic acids having 4 to 20 carbon atoms and aromatic dicarboxylic acids having 8 to 20 carbon atoms are preferred. Specific examples of the polycarboxylic acid having 3 or more valences (2-2) include aromatic polycarboxylic acids having 9 to 20 carbon atoms such as trimellitic acid and pyromellitic acid. The polycarboxylic acid (2) can be formed from a reaction between the polyol (1) and the above-mentioned acids anhydride or lower alkyl esters such as a methyl ester, ethyl ester and isopropyl ester.

The polyol (1) and polycarboxylic acid (2) are mixed such that the equivalent ratio ([OH]/[COOH]) of the hydroxyl group [OH] and a carboxylic group [COOH] is typically from 2/1 to 1/1, preferably from 1.5/1 to 1/1 and more preferably from 1.3/1 to 1.02/1.

Specific examples of the polyisocyanate (3) include aliphatic polyisocyanates such as tetramethylenediisocyanate, hexamethylenediisocyanate and 2,6-diisocyanatemethylcaproate; alicyclic polyisocyanates such as isophoronediisocyanate and cyclohexylmethanediisocyanate; aromatic diisocyanates such as tolylenedisocyanate and diphenylmethanediisocyanate; aromatic aliphatic diisocyanates such as α, α, α′, α′-tetramethylxylylenediisocyanate; isocyanurates; the above-mentioned polyisocyanates blocked with phenol derivatives, oxime and caprolactam; and their combinations.

The polyisocyanate (3) is mixed with a polyester such that the equivalent ratio ([NCO]/[OH]) of the isocyanate group [NCO] and the polyester having a hydroxyl group [OH] is typically from 5/1 to 1/1, preferably from 4/1 to 1.2/1 and more preferably from 2.5/1 to 1.5/1. When [NCO]/[OH] is greater than 5, the low temperature fixability of the resultant toner deteriorates. When [NCO] has a molar ratio less than 1, the urea content of the ester of the modified polyester decreases and the hot offset resistance of the resultant toner deteriorates. The content of the polyisocyanate (3) in the polyester prepolymer (A) having a polyisocyanate group at its end portion is from 0.5 to 40% by weight, preferably from 1 to 30% by weight and more preferably from 2 to 20% by weight. When the content is less than 0.5% by weight, the hot offset resistance of the resulting toner deteriorates and in addition the heat resistance and low temperature fixability of the toner also deteriorate. In contrast, when the content of the polyisocyanate (3) is greater than 40% by weight, the low temperature fixability of the resulting toner deteriorates.

The number of isocyanate groups in a molecule of the polyester prepolymer (A) is at least 1, preferably from 1.5 to 3 on average, and more preferably from 1.8 to 2.5 on average. When the number of isocyanate groups is less than 1 per molecule of polyester prepolymer (A), the molecular weight of the urea-modified polyester decreases and the hot offset resistance of the resulting toner deteriorates.

In the present invention, the elongation agent and/or crosslinker are preferably the amines (B).

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked. Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc. Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine is mixed with a small amount of a polyamine (B2) are preferred.

The molecular weight of the urea-modified polyesters can optionally be controlled with an elongation inhibitor, if desired. Specific examples of the elongation inhibitor include monoamines such as diethyle amine, dibutyl amine, butyl amine and lauryl amine, and blocked amines, i.e., ketimine compounds prepared by blocking the monoamines mentioned above.

The mixing ratio (i.e., the ratio [NCO]/[NHx]) of the amount of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, the molecular weight of the urea-modified polyester (i) decreases, resulting in the deterioration of hot offset resistance of the resulting toner. The urea-modified polyester (i) of the present invention may include a urethane functional group as well as a urea functional group. The molar ratio (urea/urethane) of the urea functional groups to the urethane functional groups is from 100/0 to 10/90, preferably from 80/20 to 20/80 and more preferably from 60/40 to 30/70. When the amount of the urea functional groups is less than 10%, the hot offset resistance of the resulting toner deteriorates.

The urea-modified polyester (i) can be produced by a method such as a prepolymer method. The weight-average molecular weight of the urea-modified polyester is not less than 10,000, preferably from 20,000 to 10,000,000 and more preferably from 30,000 to 1,000,000. When the weight-average molecular weight is less than 10,000, the hot offset resistance of the resulting toner deteriorates. The number-average molecular weight of the urea-modified polyester is not particularly limited when the below-mentioned unmodified polyester (ii) is used in combination with the urea-modified polyester (i). Namely, the weight-average molecular weight of the urea-modified polyester resins has priority over the number-average molecular weight thereof. However, when the urea-modified polyester (i) is used alone, the number-average molecular weight is from 2,000 to 15,000, preferably from 2,000 to 10,000 and more preferably from 2,000 to 8,000. When the number-average molecular weight is greater than 20,000, the low temperature fixability of the resulting toner deteriorates, and in addition the glossiness of full color images produced with the resulting toner deteriorates.

In the present invention, not only the urea-modified polyester (i) alone but also the unmodified polyester (ii) may be included as a toner binder with the urea-modified polyester (i). A combination thereof improves the low temperature fixability of the resulting toner and the glossiness of color images produced thereby, and the combination is more preferred than the urea-modified polyester (i) alone. Suitable unmodified polyesters (ii) include polycondensation products of the polyol (1) and polycarboxylic acid (2) similar to the urea-modified polyester (i) and specific examples thereof are the same as those of the urea-modified polyester (i). In addition, for the urea-modified polyester (i), not only the unmodified polyester (ii) but also polyester resins modified by functional groups such as urethane functional groups, other than urea functional groups, can also be used together. It is preferred that the urea-modified polyester (i) at least partially mixed with the unmodified polyester (ii) to improve the low temperature fixability and hot offset resistance of the resulting toner. Therefore, the urea-modified polyester (i) preferably has a structure similar to that of the unmodified polyester (ii). The mixing ratio (urea-modified polyester (i)/unmodified polyester) of the urea-modified polyester (i) and unmodified polyester is from 5/95 to 80/20, preferably from 5/95 to 30/70, more preferably from 5/95 to 25/75, and even more preferably from 7/93 to 20/80. When the urea-modified polyester (i) is less than 5%, the hot offset resistance deteriorates, and in addition, it is disadvantageous to have both high temperature preservability and low temperature fixability.

The unmodified polyester (ii) usually has a peak molecular weight of from 1,000 to 30,000, preferably from 1,500 to 10,000, and more preferably from 2,000 to 8,000. When the peak molecular weight is less than 1,000, high temperature preservability of the resultant toner deteriorates. When the peak molecular weight is greater than 10,000, the low temperature fixability of the resulting toner deteriorates. The unmodified polyester (ii) preferably has a hydroxyl value of not less than 5, more preferably of from 10 to 120, and furthermore preferably of from 20 to 80. When the hydroxyl value is less than 5, it is difficult for the resultant toner to have both high temperature preservability and low temperature fixability. The unmodified polyester (ii) preferably has an acid value of from 1 to 30, and more preferably from 5 to 20. An unmodified polyester (ii) having such acid values tends to be negatively charged. When the hydroxyl value and acid value are greater than 120 and 30 respectively, the resulting toner tends to be affected by high or low temperature and humidity environments, and therefore tends to produce deteriorated images.

In the present invention, a masterbatch of a colorant is provided by previously kneading a colorant with at least a binder resin and a pigment dispersant in the presence of an organic solvent or water. The colorant and binder resin sufficiently adhere to each other and the colorant is effectively and stably dispersed even after any production process. The resulting toner includes well dispersed colorant, a small dispersion diameter thereof and has good transparency.

Specific examples of the binder resin include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butylmethacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins may be used individually or in combination.

Specific examples of the method of previously kneading a mixture of a binder resin, a colorant and a pigment dispersant with an organic solvent or water include a method of mixing a binder resin, a colorant, a pigment dispersant and an organic solvent with a blending device such as a Henschel mixer; and kneading the mixture with a kneader such as two-roll and three-roll mills at a lower temperature than the melting point of the binder resin. Specific examples of the organic solvent include typical organic solvents, in view of the solubility of the binder resin in these solvents. Particularly preferred solvents include, for example, acetone, toluene, butanone and the like solvents, in view of the dispersibility of the colorant therein.

In addition, flushing methods can be used, in which an aqueous paste including a colorant is mixed with a resin solution of an organic solvent to transfer the colorant to the resin solution, and then the aqueous liquid and organic solvent are separated and removed. These flushing methods may be preferred because the resulting wet cake of the colorant can be used as it is. Of course, a dry powder which is prepared by drying the wet cake can also be used as a colorant. In this case, a three-roll mill is preferably used for kneading the mixture by the application of high shear stress.

Known pigment dispersion auxiliaries may also be included in the master batch to further increase dispersion of the colorant in the resin.

These methods not only provide colorants with a small particle diameter, but also increase the uniformity of the dispersion, and therefore the color reproducibility of a projected image by an OHP is further improved.

Furthermore, the colorant of the toner of the present invention preferably has a number-average particle diameter not greater than 0.5 μm, more preferably not greater than 0.4 μm, and furthermore preferably not greater than 0.3 μm. When the number-average particle diameter is greater than 0.5 μm, the colorant does not have a sufficient dispersibility and the resulting toner does not have targeted transparency. The colorant having a number-average particle diameter of not less than 0.7 μm is preferably not greater than 5 number %.

A colorant having a fine particle diameter of less than 0.1 μm is basically considered not to have an adverse effect on light reflection and absorption of the resulting toner.

A colorant having a particle diameter of less than 0.1 μm contributes to the transparency of an OHP sheet having good color reproducibility and image fixability. To the contrary, a large number of the colorants having a particle diameter greater than 0.5 μm tend to essentially deteriorate the brightness and chromaticness of a projected image on an OHP sheet.

Furthermore, a large amount of the colorants having a particle diameter greater than 0.5 μm are released from a surface of the toner particle, and tend to cause various problems such as background development, drum contamination and poor cleaning. When such a toner is used in a two-component developer, the carrier is contaminated and quality images are difficult to produce in a stable manner when many images are durably produced. Of course, good color reproducibility and uniform chargeability of the toner cannot be expected.

Suitable colorants for the toner of the present invention include known dyes and pigments. Specific examples of the colorants include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS andBC), Indigo, ultramarine, Prussianblue, AnthraquinoneBlue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials may be used alone or in combination.

The content of the colorant in the toner is preferably from 1 to 15% by weight, and more preferably from 3 to 10% by weight, based on total weight of the toner.

Any known pigment dispersants and pigment dispersion auxiliaries can be used in the present invention. To stabilize a dispersion of fine particles in a liquid, a method of increasing a potential energy barrier to prevent mutual contact of the particles or a method of using the steric hindrance effect of a term molecule adhered to the surface of the particles so as to prevent particles from becoming so close to each other that the mutual Van der Waal's forces of the particles are available. The dispersion medium of the present invention for the colorant may be an organic solvent which includes a dissolved binder resin. Electrostatic repulsion cannot be expected from such a non-aqueous dispersion medium because of its low permittivity. Therefore, a polymeric dispersant is preferred. In particular, the polymeric dispersant preferably has a functional group having a strong interaction with the surface molecules of the colorant, and has a chemical structure such that a segment elongated in the dispersion medium exerts its steric hindrance repulsion after adhering to the surface of the colorant. In particular, the polymeric dispersant preferably has a functional group at its end. Commercially available SOLSPERSE is preferably used as the polymeric dispersant.

The colorant preferably includes pigment dispersants and pigment dispersion auxiliaries in an amount of from 1 to 30% by weight based on total weight of the colorant.

Specific examples of the pigment dispersants of the present invention include known polymeric dispersants such as polyester resins, polycaprolactone resins, acrylic resins, unsaturated polyester resins, photosensitive monomers having a (metha)acryloyl group and oligomers. In addition, polyesteracrylate or its hydrolysates, polyester (meth) acrylate or its hydrolysates, polyvinylacetate or partially saponified polyvinylacetate, polyvinylphenol, phenolnovolak resins, polystyrene, polyvinylbutyral, polychloroprene, polyvinylchloride, polyethylenechloride, polypropylenechloride, polyvinylpyrrolidone, copolymers of styrene and maleic anhydride or their half esters, and additional polymers prepared from copolymerizable monomers such as acrylic acid, (meth)acrylic acid, acrylate esters, (meth)acrylate esters, acrylamide, (meth)acrylamide, acrylonitrile, and (meth)acrylonitrile. In view of the chargeability of the resultant toner and the dispersibility with a toner binder, similar resins to the toner binder are preferred.

The pigment dispersion auxiliaries of the present invention are not particularly limited provided that they have a strong interaction with the pigment dispersant as well as the pigment. However, derivatives or precursors of a pigment having a structure in common with the pigment are preferred because of their high affinity with the pigment. In addition, the derivatives or precursors of the pigment preferably have a polar functional group having high affinity with a pigment dispersant because of the strong interaction of the polar functional group with the pigment dispersant. The interaction between the pigment dispersants and pigment dispersion auxiliaries may be hydrogen bonding interaction or an acid-base interaction. The pigment dispersion auxiliaries preferably have functional groups such as hydroxyl groups and amide groups to enhance the hydrogen bonding interaction. In addition, the pigment dispersion auxiliaries preferably have basic functional groups such as amino groups when the pigment dispersant has an acidic functional group, and the pigment dispersion auxiliaries preferably have acidic functional groups such as carboxyl groups and sulfonate groups when the pigment dispersant has a basic functional group.

The toner of the present invention may include a wax together with a toner binder and a colorant. Specific examples of the wax include known waxes, e.g., polyolefin waxes such as polyethylene wax and polypropylene wax; long chain carbon hydrides such as paraffin wax and sasol wax; and waxes including carbonyl groups. Among these waxes, the waxes including carbonyl groups are preferred. Specific examples thereof include polyesteralkanate waxes such as carnauba wax, montan wax, trimethylolpropanetribehenate, pentaelislitholtetrabehenate, pentaelislitholdiacetatedibehenate, glycerinetribehenate and 1,18-octadecanedioldistearate; polyalkanolesters such as tristearyltrimellitate and distearylmaleate; polyamidealkanates such as ethylenediaminebehenylamide; polyalkylamides such as tristearylamidetrimellitate; and dialkylketones such as distearylketone. Among these waxes having a carbonyl group, polyesteralkanates are preferred. The wax of the present invention usually has a melting point of from 40 to 160° C., preferably of from 50 to 120° C., and more preferably of from 60 to 90° C. A wax having a melting point of less than 40° C. has an adverse effect on its high temperature preservability, and a wax having a melting point of greater than 160° C. tends to cause cold offset of the resulting toner when fixed at a low temperature. In addition, the wax preferably has a melting viscosity of from 5 to 1,000 cps, and more preferably of from 10 to 100 cps when measured at a temperature higher by 20° C. than the melting point. A wax having a melting viscosity greater than 1,000 cps makes it difficult to improve the hot offset resistance and the low temperature fixability of the resulting toner.

The content of the wax in the toner is preferably from 0 to 40% by weight, and more preferably from 3 to 30% by weight.

The toner of the present invention preferably has a glass transition temperature (Tg) of from 40 to 70° C., and more preferably of from 45 to 65° C. When the glass transition temperature is less than 40° C., the high temperature preservability of the resulting toner deteriorates. When the Tg of the toner is greater than 70° C., the low temperature fixability thereof becomes insufficient. Due to the presence of the urea-modified polyester, the toner of the present invention has better high temperature preservability than known toners having a polyester binder resin, even though the glass transition temperature is low. The toner binder preferably has a temperature (TG′) of not less than 100° C., and more preferably of from 110 to 200° C. at which temperature the storage modulus of the toner binder is 10,000 dyne/cm² at a measuring frequency of 20 Hz. When the TG′ of the toner binder is less than 100° C., the hot offset resistance of the resulting toner deteriorates. The toner binder preferably has a temperature (Tη) of not greater than 180° C., and more preferably of from 90 to 160° C. at which temperature the viscosity of the toner binder is 1,000 poise at a measuring frequency of 20 Hz. When the Tη is greater than 180° C., the low temperature fixability of the resulting toner deteriorates. Namely, TG′ is preferably higher than Tη in view of the compatibility between the hot offset resistance and the low temperature fixability, i.e., a difference between TG′ and Tη (TG′-Tη) is preferably not less than 0° C., more preferably not less than 10° C., and furthermore preferably not less than 20° C. The upper limit of the difference is not particularly limited. In addition, in view of compatibility between the high temperature preservability and the low temperature fixability, the difference between Tη and Tg is preferably from 0 to 100° C., more preferably from 10 to 90° C., and particularly preferably from 20 to 80° C.

The toner of the present invention preferably has a specific shape and a distribution thereof. An amorphous toner having an average circularity of less than 0.94 and being too far from being spherical does not have sufficient transferability and produce high quality images without toner scattering. Various methods for measuring the shape may be used. For example, an optical detecting belt passing a suspension liquid including a particulate material through a plate image detecting belt and optically detecting an image of the particulate material with a CCD camera is preferred. The circularity is a value calculated by dividing the circumferential length of a circle having an equivalent area to a projected area obtained by this method with a circumferential length of an actual particulate material.

A toner having an average circularity of from 0.94 to 1.00 is effectively used to form fine images with proper density. The toner preferably has an average circularity of from 0.98 to 1.00, and not greater than 10% of particles have a circularity of less than 0.95. The average circularity is measured by a flow-type particle image analyzer such as FPIA-2000 from SYSMEX CORP.

Specifically, 0.1 to 0.5 ml of a detergent, preferably an alkylbenzenesulfonic acid salt as a dispersant is added to 100 to 150 ml of water from which impure solid matter has previously been removed, and a further 0.1 to 0.5 g of a measurement sample is added thereto. The suspension liquid including the sample is dispersed by an ultrasonic disperser for about 1 to 3 min until the dispersed liquid has a concentration of from 3,000 to 10,000 μl, and is measure by the flow-type particle image analyzer.

The toner of the present invention preferably has a volume-average particle diameter (Dv) of from 4 to 8 μm and a ratio thereof to a number-average particle diameter (Dn) thereof (Dv/Dn) of not greater than 1.25, and more preferably of from 1.10 to 1.25. Such a toner has good high temperature preservability, low temperature fixability and hot offset resistance, and particularly produces images having good glossiness when used in a full-color copier. Further, when used in a two-component developer, even after the toner is consumed and fed for a long time, the toner particle diameter has less variation. In addition, even being after agitated in an image developer for a long time, the toner has good and stable developability. When used in a one-component developer, even after the toner is consumed and fed for a long time, toner filming over the developing roller and toner adherence over a blade for making a thin layer of the toner do not occur. In addition, even after being agitated in an image developer for a long time, the toner has good and stable developability.

Generally, the smaller the particle diameter of the toner, the better it produces high resolution and quality images. However, small particle diameters are a disadvantage for transferability and cleanability. When the Dv is less than the above-mentioned range, the toner in a two-component developer adheres to a surface of a carrier due to long agitation in an image developer, resulting in deterioration of the chargeability of the carrier. The toner in a one-component developer tends to cause filming over a developing roller and adheres to a member such as a blade.

These phenomena also occur when the content of fine particles in the toner is greater than the above-mentioned range.

When the Dv is greater than the above-mentioned range, the Dv tends to vary much and it is difficult to produce high resolution and quality images. In addition, when Dv/Dn is greater than 1.25, a similar problem occurs.

The toner of the present invention may optionally include a charge controlling agent. Materials almost colorless or white are preferred because colored materials cause a color change in the resulting toner. Specific examples of the charge controlling agent include known charge controlling agents such as triphenylmethane dyes, chelate compounds of molybdic acid, Rhodamine dyes, alkoxyamines, quaternary ammonium salts (including fluorine-modified quaternary ammonium salts), alkylamides, phosphor or compounds including phosphor, tungsten or compounds including tungsten, fluorine-containing activators, metal salts of salicylic acid, salicylic acid derivatives, etc. Specific examples of commercially available charge controlling agents include BONTRON P-51 (quaternary ammonium salt), E-82 (metal complex of oxynaphthoic acid), E-84 (metal complex of salicylic acid), and E-89 (phenolic condensationproduct), whicharemanufacturedbyOrientChemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The content of the charge controlling agent depends on the species of the binder resin used, whether or not an additive is added and the toner manufacturing method (such as dispersion method), and is not particularly limited. However, the amount of the charge controlling agent is typically from 0.1 to 10 parts by weight, and preferably from 0.2 to 5 parts by weight, per 100 parts by weight of the binder resin included in the toner. When the amount is too high, the toner has too large an amount of charge, and thereby the electrostatic force of a developing roller attracting the toner increases, resulting in a deterioration of the fluidity of the toner and a decrease of the image density of toner images. These charge controlling agents can be dissolved and dispersed after kneading and heating them with a master batch pigment and resin, and can be added when directly dissolved and dispersed in an organic solvent or can be fixed on a toner surface after the toner particles are produced.

Resin fine particles are added to the toner of the present invention. Any thermoplastic and thermosetting resins can be used provided they can form an aqueous dispersion. Specific examples of the resins include vinyl resins, polyurethane resins, epoxy resins, polyester resins, polyamide resins, polyimide resins, silicon resins, phenol resins, melamine resins, urea resins, aniline resins, ionomer resins and polycarbonate resins. These resins may be used in combination. Among these resins, vinyl resins, polyurethane resins, epoxy resins, polyester resins and their combinations are preferred because an aqueous dispersion of fine spheric resin particles can easily be obtained.

Specific examples of the vinyl resins include polymers formed of homopolymerized or copolymerized vinyl monomers such as styrene-(meth)acrylate ester resins, styrene-butadiene copolymers, (meth)acrylic acid-esteracrylate polymers, styrene-acrylonitrile copolymers, styrene-maleic acid anhydride copolymers and styrene-(meth)acrylic acid copolymers.

In the present invention, the resin fine particles preferably have an average particle diameter of from 5 to 500 nm.

In organic fine particles are preferably used as an external additive for improving fluidity, developability and chargeability of the colored particles of the present invention. The inorganic fine particles preferably have a primary particle diameter of from 5 nm to 2 μm, and more preferably from 5 nm to 500 nm. In addition, the specific surface area of the inorganic fine particles measured by the BET method is preferably from 20 to 500 m²/g. The amount of the external additive is preferably from 0.01 to 5% by weight, and more preferably from 0.01 to 2.0% by weight, based on total weight of the toner composition. Specific examples of the inorganic fine particles include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Other than these materials, polymer fine particles such as polystyrene formed by a soap-free emulsifying polymerization, a suspension polymerization or a dispersing polymerization, methacrylate ester or acrylate ester copolymers, silicone resins, benzoguanamine resins, polycondensation fine particles such as nylon and polymer particles of thermosetting resins can be used.

These fluidizers, i.e., surface treatment agents can increase hydrophobicity and prevent deterioration of the fluidity and chargeability of the resulting toner even in high humidity. Specific examples of surface treatment agents include silane coupling agents, silylating agents, silane coupling agents having an alkyl fluoride group, organic titanate coupling agents, aluminium coupling agents silicone oils and modified silicone oils.

The toner of the present invention may include a cleanability improver for removing the developer remaining on the photoreceptor and the first transfer medium after transferring. Specific examples of the cleanability improver include fatty acid metallic salts such as zinc stearate, calcium stearate and stearic acid; and polymer fine particles prepared by a soap-free emulsifying polymerization method such as polymethylmethacrylate fine particles and polystyrene fine particles. The polymer fine particles comparatively have a narrow particle diameter distribution and preferably have a volume-average particle diameter of from 0.01 to 1 μm.

The toner binder of the present invention can be prepared, for example, by the following method. Polyol (1) and polycarboxylic acid (2) are heated to a temperature of from 150 to 280° C. in the presence of a known catalyst such as tetrabutoxy titanate and dibutyltinoxide. Then water generated is removed, under reduced pressure if desired, to provide a polyester resin having a hydroxyl group. Then the polyester resin is reacted with polyisocyanate (3) at a temperature of from 40 to 140° C. to provide a prepolymer (A) having an isocyanate group. Then, the prepolymer (A) is reacted with an amine (B) at a temperature of from 0 to 140° C., to provide a urea-modified polyester (i). A solvent can be used if desired when the polyisocyanate, and A and B are reacted. Suitable solvents include solvents which do not react with a polyisocyanate. Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoaminde; ethers such as tetrahydrofuran. When a polyester which does not have a urea functional group (ii) is used in combination with the urea-modified polyester, polyester (ii) is prepared by a method similar to that used for preparing the polyester resins having a hydroxyl group, and the polyester (ii) is added to the solution of the polyester (i) after the reaction of forming the polyester (i) has been completed.

The toner of the present invention is produced by the following method, but the method is not limited thereto.

The aqueous medium of the present invention includes water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

The toner of the present invention can be prepared by reacting a dispersion formed of the prepolymer (A) having an isocyanate group with (B) or using the previously prepared urea-modified polyester (i). As a method of stably preparing a dispersion formed of the urea-modified polyester (i) or the prepolymer (A) in an aqueous medium, a method of including toner constituents such as the urea-modified polyester (i) or the prepolymer (A) into an aqueous medium and dispersing them upon application of shear stress is preferred. A prepolymer (A) and other toner constituents such as colorants, master batch pigments, release agents, charge controlling agents, unmodified polyester resins, etc. may be added into an aqueous medium at the same time when the dispersion is prepared. However, it is preferable that the toner constituents are previously mixed and then the mixed toner constituents are added to the aqueous liquid at the same time. In addition, colorants, release agents, charge controlling agents, etc., are not necessarily added to the aqueous dispersion before particles are formed, and may be added thereto after particles are prepared in the aqueous medium. A method of dyeing particles previously formed without a colorant by a known dying method can also be used.

The dispersion method is not particularly limited, and low speed shearing methods, high-speed shearing methods, friction methods, high-pressure jet methods, ultrasonic methods, etc. may be used. Among these methods, high-speed shearing methods are preferably used because particles having a particle diameter of from 2 to 20 Am can be easily prepared. At this point, the particle diameter (2 to 20 μm) means a particle diameter of particles including a liquid. When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C. When the temperature is relatively high, the urea-modified polyester (i) or prepolymer (A) can easily be dispersed because the dispersion formed thereof has a low viscosity.

The amount of the aqueous medium to 100 parts by weight of the toner constituents including the urea-modified polyester (i) or prepolymer (A) is typically from 50 to 2,000 parts by weight, and preferably from 100 to 1,000 parts by weight. When the content is less than 50 parts by weight, the dispersion of the toner constituents in the aqueous medium is not satisfactory, and thereby the resulting mother toner particles do not have the desired particle diameter. In contrast, when the amount of the aqueous medium is greater than 2,000, the production cost increases. A dispersant can preferably be used to prepare a stably dispersed dispersion including particles having a sharp particle diameter distribution.

To synthesize the urea-modified polyester (i) from the prepolymer (A), the amines (B) may be added to the toner constituents before being dispersed in an aqueous medium or after being dispersed. In this case, the urea-modified polyester is formed on a surface of the toner by priority and a concentration gradient can be formed in particles.

Specific examples of the dispersants used to emulsify and disperse an oil phase for a liquid including water, in which the toner constituents are dispersed, include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi (aminoethyl) glycin, di) octylaminoethyle) glycin, and N-alkyl-N,N-dimethylammonium betaine.

A surfactant having a fluoroalkyl group can provide a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl (C6-C10) sulfoneamidepropyltrimethylammonium salts, salts of perfluoroalkyl (C6-C10)-N-ethylsulfonylglycin, monoperfluoroalkyl (C6-C16) ethylphosphates, etc.

Specific examples of commercially available surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNEDS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of cationic surfactants which can disperse an oil phase including toner constituents in water, include primary, secondary and tertiary aliphatic amines having a fluoroalkyl group, aliphatic quaternary ammonium salts such as perfluoroalkyl (C6-C10) sulfoneamidepropyltrimethylammonium salts, benzalkonium salts, benzetonium chloride, pyridinium salts, imidazolinium salts, etc. Specific examples of commercially available cationic surfactants include SURFLON S-121 (from Asahi Glass Co., Ltd.); FRORARDFC-135 (from Sumitomo 3MLtd.); UNIDYNEDS-202 (fromDaikinIndustries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

In addition, inorganic compound dispersants such as tricalcium phosphate, calcium carbonate, titanium oxide, colloidal silica and hydroxyapatite which are barely insoluble in water can also be used.

In addition, it is possible to stably disperse toner constituents in water using a polymeric protection colloid. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

When an acid such as calcium phosphate or a material soluble in alkaline is used as a dispersant, the calcium phosphate is dissolved with an acid such as hydrochloric acid and washed with water to remove the calcium phosphate from the toner particle. In addition, calcium phosphate may also be removed by an enzymatic hydrolysis method.

When a dispersant is used, the dispersant may remain on the surface of the toner particle. However, the dispersant is preferably washed and removed after the elongation and/or crosslinking reaction of the prepolymer with an amine.

In order to decrease the viscosity of the dispersion medium including the toner constituents, a solvent which can dissolve the urea-modified polyester (i) or prepolymer (A) can be used because the resulting particles have a sharp particle diameter distribution. The solvent is preferably volatile and has a boiling point lower than 100° C. so it can be easily removed from the dispersion after the particles are formed. Specific examples of such a solvent include toluene, xylene, benzene, carbon tetrachloride, methylene chloride, 1, 2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferred. The quantity of such solvent which is added is from 0 to 300 parts by weight, preferably from 0 to 100, and more preferably from 25 to 70 parts by weight, per 100 parts by weight of the prepolymer (A) used. When such a solvent is used to prepare a particle dispersion, the solvent is removed therefrom under a normal or reduced pressure after the particles are subjected to an elongation reaction and/or a crosslinking reaction of the prepolymer with an amine.

The elongation and/or crosslinking reaction time depends on the reactivity of the isocyanate structure of the prepolymer (A) and amine (B), but is typically from 10 min to 40 hrs, and preferably from 2 to 24 hrs. The reaction temperature is typically from 0 to 150° C., and preferably from 40 to 98° C. In addition, a known catalyst such as dibutyltinlaurate and dioctyltinlaurate can be used.

The organic solvent may be removed from an emulsified dispersion by gradually raising the temperature of the whole dispersion, thereby completely removing the organic solvent in the droplet by vaporization. Otherwise, the emulsified dispersion may be sprayed in dry air, or completely removing a water-insoluble organic solvent in the droplet to form toner fine particles and removing a water dispersant by vaporizing. Typically, the dry air may include atmospheric air, nitrogen gas, carbon dioxide gas, a gaseous body in which a combustion gas is heated, and particularly various aerial currents heated to have a temperature of not less than the boiling point of the solvent used. A spray dryer, a belt dryer and a rotary kiln can sufficiently remove the organic solvent in a short time.

When an emulsified dispersion is washed and dried while maintaining a wide particle diameter distribution thereof, the dispersion can be classified to have the desired particle diameter distribution.

A cyclone, a decanter, a centrifugal separator, etc. can remove fine particles in a dispersion liquid. After the dispersion liquid is dried, the powder can be classified, but for purposes of efficiency, the liquid is preferably classified. Unnecessary fine and coarse particles can be recycled to a kneading process to form particles. The fine and coarse particles may be wet when recycled.

The dispersant is preferably removed from the dispersion liquid, and preferably removed and classified at the same time.

Heterogeneous particles such as release agent fine particles, charge controlling fine particles, fluidizing fine particles and colorant fine particles can be mixed with a toner powder after being dried. Release of the heterogeneous particles from composite particles can be prevented by subjecting the mixed powder to a mechanical stress in order to fix and fuse the heterogeneous particles on the surface of the composite particles.

Specific methods include applying a strong impact on a mixture with a blade rotating at high-speed, putting the mixture in a high-speed stream and accelerating the mixture such that the particles thereof collide each other or composite particles thereof collide with a collision board, etc. Specific examples of the apparatus include an ONG MILL from Hosokawa Micron Corp., a modified I-type mill having a lower pulverizing air pressure from Nippon Pneumatic Mfg. Co., Ltd., a hybridization system from Nara Machinery Co., Ltd., a Kryptron System from Kawasaki Heavy Industries, Ltd., an automatic mortar, etc.

The toner of the present invention can be used in a two-component developer in which the toner is mixed with a magnetic carrier. The amount of the toner is preferably from 1 to 10 parts by weight per 100 parts by weight of the carrier. Suitable carriers for use in the two component developer include known carrier materials such as iron powders, ferrite powders, magnetite powders, magnetic resin carriers, which have a particle diameter of from about 20 to about 200 μm. The surface of the carrier may be coated by a resin. Specific examples of such resins for coating on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins. An electroconductive powder may optionally be included in the toner. Specific examples of such electroconductive powders includemetalpowders, carbonblacks, titaniumoxide, tinoxide, and zinc oxide. The average particle diameter of such electroconductive powders is preferably not greater than 1 μm. When the particle diameter is too large, it is hard to control the resistance of the resulting toner.

The toner of the present invention can also be used as a one-component magnetic developer or a one-component non-magnetic developer.

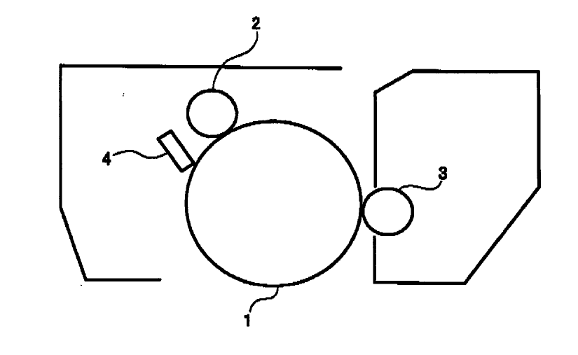

FIG. 1 provides a schematic view of one embodiment of a process cartridge according to the present invention. The process cartridge may be detachably installed in a copier, and comprises a photoreceptor (1), a charger (2), and image developer (3), and a cleaner (4). In the present invention, the process cartridge includes the photoreceptor and at least one of the charger, image developer, and cleaner.

In an image forming apparatus including the process cartridge of the present invention, the photoreceptor is rotated at a predetermined peripheral speed. The peripheral surface of the photoreceptor is uniformly positively or negatively charged by the charger when rotated. Then, the peripheral surface of the photoreceptor is irradiated with imagewise light by a slit irradiator, a laser beam scanning irradiator, etc., to form an electrostatic latent image thereon. The electrostatic latent image is developed by an image developer to form a toner image on the peripheral surface of the photoreceptor. The toner image is transferred onto a transfer sheet fed between the photoreceptor and a transferer from a paper feeder in sync with a rotation of the photoreceptor. The transfer sheet on which the toner image is transferred separates from the peripheral surface of the photoreceptor and fed to an image fixer to fix the toner image thereon, and fed out of the apparatus as a duplicate copy. The peripheral surface of the photoreceptor is cleaned by a cleaner to remove residual toner after it is transferred, and is discharged to be prepared for forming the following image.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Production Example 1

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of ammonium persulfate were mixed in a reactor vessel including a stirrer and a thermometer, and the mixture was stirred for 15 min at 400 rpm to prepare a white emulsion therein. The white emulsion was heated to a temperature of 75° C. and reacted for 5 hrs. Then, 30 parts of an aqueous solution of persulfate ammonium having a concentration of 1% were added thereto and the mixture was reacted for 5 hrs at 75° C. to provide an aqueous dispersion [a fine particle dispersion liquid 1] of a vinyl resin (a copolymer of a sodium salt of an adduct of styrene-methacrylate-butylacrylate-sulfuric ester with ethyleneoxide methacrylate). The fine particle dispersion liquid 1 was analyzed by a LA-920 device, and the volume-average particle diameter thereof was 105 nm. A portion of the fine particle dispersion liquid 1 was dried to isolate a resin component therefrom. The resin component had a Tg of 59° C. and weight-average molecular weight of 150,000.

### Production Example 2

990 parts of water, 83 parts of the fine particle dispersion liquid 1, 37 parts of an aqueous solution of sodium dodecyldiphenyletherdisulfonate having a concentration of 48.5% (ELEMINOL MON-7 from Sanyo Chemical Industries, Ltd.) and 90 parts of ethyl acetate were mixed and stirred to prepare an aqueous liquid [an aqueous phase 1].

### Production Example 3

319 parts of an adduct of bisphenol A with 2 moles of propyleneoxide, 449 parts of an adduct of bisphenol A with 2 moles of ethyleneoxide, 243 parts terephthalic acid, 53 parts of adipic acid and 2 parts of dibutyltinoxide were mixed and reacted in a reactor vessel including a cooling pipe, a stirrer and a nitrogen lead-in pipe for 8 hrs at a normal pressure and 230° C. Further, after the mixture was depressurized by 10 to 15 mm Hg and reacted for 5 hrs, 7 parts of trimellitic acid anhydride was added thereto and reacted for 2 hrs at 180° C. and a normal pressure to prepare low-molecular-weight polyester 1. The low-molecular-weight polyester 1 had a number-average molecular weight of 1,900, a weight-average molecular weight of 6,100, a Tg 43° C. and an acid value of 1.1.

### Production Example 4

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen lead-in pipe for 8 hrs at a normal pressure and 230° C. Then, the mixture was depressurized by 10 to 15 mm Hg and reacted for 5 hrs to provide an intermediate polyester 1. The intermediate polyester 1 had a number-average molecular weight of 2,100, a weight-average molecular weight of 9,500, a Tg 55° C. and an acid value of 0.5 and a hydroxyl value of 51.

Next, 410 parts of the intermediate polyester 1, 89 parts of isophoronediisocyanate and 500 parts of ethyl acetate were reacted in a reactor vessel including a cooling pipe, a stirrer and a nitrogen lead-in pipe for 5 hrs at 100° C. to provide a prepolymer 1. The prepolymer 1 includes a free isocyanate in an amount of 1.53% by weight.

### Production Example 5

170 parts of isophorondiamine and 75 parts of methyl ethyl ketone were reacted at 50° C. for 5 hrs in a reaction vessel including a stirrer and a thermometer to provide a ketimine compound 1. The ketimine compound 1 had an amine value of 418.

### Example 1

30 parts of water, 50 parts of C.I. Pigment Blue 15:3 (LIONOL BLUE FG-7351 from Toyo Ink Mfg. Co., Ltd.), 50 parts of the low-molecular-weight polyester 1 and 5 parts of a pigment dispersant (Solsperse S24000sc from Avecia KK) were mixed in a Henschel mixer from Mitsui Mining Co., Ltd. to provide a mixture which is a pigment aggregate including water. After the mixture was kneaded by a two-roll mill at 130° C. for 45 min, the mixture was rolled, cooled and pulverized by a pulverizer to provide a cyan master batch 1. 378 parts of the low-molecular-weight polyester 1, 110 parts of synthetic ester wax, 22 parts of charge controlling agent (salicylic acid metal complex E-84 from Orient Chemical Industries Co., Ltd.) and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the cyan master batch 1 and 500 parts of ethyl acetate were added to the mixture and mixed for 1 hr to provide a cyan material solution 1.

1,324 parts of the cyan material solution 1 were transferred into another vessel, and a pigment and a wax thereof were dispersed by a bead mill (an ultra visco mill from Imecs Co., Ltd. filled with zirconia beads having a diameter of 0.5 mm by 80 volume % under conditions of 3 passes at a liquid feeding speed of 1 kg/hr and a disk peripheral speed of 6 m/sec. Next, 1,324 parts of an ethyl acetate solution of the low-molecular-weight polyester 1 having a concentration of 65% were added to the cyan material solution 1 and the mixture was milled in the bead mill at one time to provide a cyan pigment and wax dispersion liquid 1. The cyan pigment and wax dispersion liquid 1 had a solid content concentration of 50% (130° C. for 30 min).

664 parts of the cyan pigment and wax dispersion liquid 1, 139 parts of the prepolymer 1 and 5.9 parts of the ketimine compound 1 were mixed in a vessel with a TK homomixer from TOKUSHU KIKA KOGYO CO., LTD. at 5,000 rpm for 1 min. 1,200 parts of the aqueous phase were added to the mixture and mixed with the TK homomixer at 13,000 rpm for 20 min to provide a cyan emulsified slurry 1.

The cyan emulsified slurry 1 was put in a vessel including a stirrer and a thermometer. After a solvent was removed from the cyan emulsified slurry 1 at 30° C. for 8 hrs, the slurry was aged at 45° C. for 4 hrs to provide a cyan dispersion slurry 1.

After the cyan dispersion slurry 1 was filtered under reduced pressure, 100 parts of ion exchanged water were added to the filtered cake and mixed with the TK homomixer at 12,000 rpm for 10 min, and the mixture was filtered.

Then, 100 parts of an aqueous solution of sodium hydrate having a concentration of 10% were added to the filtered cake and mixed with the TK homomixer at 12,000 rpm for 30 min, and the mixture was filtered under reduced pressure.

Then, 100 parts of 10% hydrochloric acid were added to the filtered cake and mixed with the TK homomixer at 12, 000 rpm for 10 min, and the mixture was filtered.

In addition, 300 parts of ion exchange water were added to the filtered cake and mixed with the TK homomixer at 12,000 rpm for 10 min, and the mixture was filtered twice to provide a cyan filtered cake 1.

The cyan filtered cake 1 was dried in an air drier at 45° C. for 48 hrs and sieved with a mesh having an opening of 75 μm to provide toner particles. Each 0.5 parts of hydrophobic silica and hydrophobic titania were mixed with 100 parts of the toner particles in a Henschel mixer to provide a cyan toner 1.

### Example 2

30 parts of water, 50 parts of C.I. Pigment Red 122 (Magenta R from Toyo Ink Mfg. Co., Ltd.), 50 parts of the low-molecular-weight polyester 1 and 8 parts of a pigment dispersant (Solsperse S24000sc from Avecia KK) were mixed in a Henschel mixer from Mitsui Mining Co., Ltd. to provide a mixture which is a pigment aggregate including water. After the mixture was kneaded with a two-roll mill at 130° C. for 45 min, the mixture was rolled, cooled and pulverized with a pulverizer to provide a magenta master batch 1.

Then, the procedures for preparing the cyan toner 1 in Example 1 were repeated except for changing the cyan master batch 1 to the magenta master batch 1 to provide a magenta toner 1.

### Example 3

30 parts of water, 50 parts of C.I. Pigment Yellow 155 (Toner Yellow 3GP from Clariant Japan KK), 50 parts of the low-molecular-weight polyester 1 and 6 parts of a pigment dispersant (Solsperse S24000sc from Avecia KK) were mixed in a Henschel mixer from Mitsui Mining Co., Ltd. to provide a mixture which is a pigment aggregate including water. After the mixture was kneaded by a two-roll mill at 130° C. for 45 min, the mixture was rolled, cooled and pulverized with a pulverizer to provide a yellow master batch 1.

Then, the procedures for preparing the cyan toner 1 in Example 1 were repeated except for changing the cyan master batch 1 to the yellow master batch 1 to provide a yellow toner 1.

### Example 4

30 parts of water, 50 parts of carbon black (Printex 60 from Daicel-Degussa Ltd.), 50 parts of the low-molecular-weight polyester 1 and 4 parts of a pigment dispersant (Solsperse S24000sc from Avecia KK) were mixed in a Henschel mixer from Mitsui Mining Co., Ltd. to provide a mixture which is a pigment aggregate including water. After the mixture was kneaded by a two-roll mill at 130° C. for 45 min, the mixture was rolled, cooled and pulverized with a pulverizer to provide a black master batch 1.

Then, the procedures for preparing the cyan toner 1 in Example 1 were repeated except for changing the cyan master batch 1 to the black master batch 1 to provide a black toner 1.

### Example 5

30 parts of water, 50 parts of C.I. Pigment Blue 15:3 (LIONOL BLUE FG-7351 from Toyo Ink Mfg. Co., Ltd.), 50 parts of the low-molecular-weight polyester 1, 5 parts of a pigment dispersant (Solsperse S24000sc from Avecia KK) and 1.25 parts of a pigment dispersion auxiliary agent (Solsperse S5000 from Avecia KK) mixed in a Henschel mixer from Mitsui Mining Co., Ltd. to provide a mixture which is a pigment aggregate including water. After the mixture was kneaded by a two-roll mill at 130° C. for 45 min, the mixture was rolled, cooled and pulverized with a pulverizer to provide a cyan master batch 2.

Then, the procedures for preparing the cyan toner 1 in Example 1 were repeated except for changing the cyan master batch 1 to the cyan master batch 2 to provide a cyan toner 2.

### Example 6

30 parts of ethyl acetate, 50 parts of C.I. Pigment Blue 15:3 (LIONOL BLUE FG-7351 from Toyo Ink Mfg. Co., Ltd.), 50 parts of the low-molecular-weight polyester 1 and 5 parts of a pigment dispersant (Solsperse S24000sc from Avecia KK) were mixed in a Henschel mixer from Mitsui Mining Co., Ltd. to provide a mixture which is a pigment aggregate including water. After the mixture was kneaded by a two-roll mill at 130° C. for 45 min, the mixture was rolled, cooled and pulverized with a pulverizer to provide a cyan master batch 3.

Then, the procedures for preparing the cyan toner 1 in Example 1 were repeated except for changing the cyan master batch 1 to the cyan master batch 3 to provide a cyan toner 3.

### Comparative Example 1

578 parts of the low-molecular-weight polyester 1, 110 parts of synthetic ester wax, 22 parts of charge a controlling agent (salicylic acid metal complex E-84 from Orient Chemical Industries Co., Ltd.) and 947 parts of ethyl acetate were mixed in a reaction vessel including a stirrer and a thermometer. The mixture was heated to a temperature of 80° C. while being stirred. After the temperature of 80° C. was maintained for 5 hrs, the mixture was cooled to a temperature of 30° C. in an hour. Then, 300 parts of C.I. Pigment Blue 15:3 (LIONOL BLUE FG-7351 from Toyo Ink Mfg. Co., Ltd.) and 500 parts of ethyl acetate were added to the mixture and mixed for 1 hr to provide a comparative cyan material solution 1.

1,324 parts of the comparative cyan material solution 1 were transferred into another vessel, and a pigment and a wax were dispersed with a bead mill (an ultra visco mill from Imecs Co., Ltd. filled with zirconia beads having a diameter of 0.5 mm by 80 volume % under conditions of 3 passes at a liquid feeding speed of 1 kg/hr and a disk peripheral speed of 6 m/sec. Next, 1,324 parts of an ethyl acetate solution of the low-molecular-weight polyester 1 having a concentration of 65% were added to the comparative cyan material solution 1 and the mixture was milled with the bead mill at one time to provide a comparative cyan pigment and wax dispersion liquid 1. The comparative cyan pigment and wax dispersion liquid 1 had a solid content concentration of 50% (130° C. for 30 min).

Then, the procedures for preparing the cyan toner 1 in Example 1 were repeated except for changing the cyan pigment and wax dispersion liquid 1 to the comparative cyan pigment and wax dispersion liquid 1 to provide a comparative cyan toner 1.

### Comparative Example 1

30 parts of water, 50 parts of C.I. Pigment Blue 15:3 (LIONOL BLUE FG-7351 from Toyo Ink Mfg. Co., Ltd.) and 50 parts of the low-molecular-weight polyester were mixed in a Henschel mixer from Mitsui Mining Co., Ltd. to provide a mixture which is a pigment aggregate including water. After the mixture was kneaded with a two-roll mill at 130° C. for 45 min, the mixture was rolled, cooled and pulverized with a pulverizer to provide a comparative cyan master batch 2.

Then, the procedures for preparing the cyan toner 1 in Example 1 were repeated except for changing the cyan master batch 1 to the comparative cyan master batch 2 to provide a comparative cyan toner 2.

Evaluation Items

(a) Particle Diameter

Specific examples of a toner particle-diameter distribution measuring device using the Coulter counter method include a Coulter Counter TA-II and a Coulter Multisizer II from Beckman Coulter, Inc. The measuring method will be explained.

First, 0.1 to 5 ml of a surfactant, preferably an alkylbenzenesulfonic acid dispersant were added in 100 to 150 ml of an electrolytic aqueous solution. The electrolytic aqueous solution is a sodium chloride aqueous solution using primary sodium chloride and having a concentration of 1%, such as ISOTON-II from Beckman Coulter, Inc. 2 to 20 mg of toner particles were added in the mixture. The electrolytic aqueous solution including the toner particles was dispersed for 1 to 3 min by an ultrasonic disperser. The toner particles or volume and number were measured by the above-mentioned measuring device using an aperture of 100 μm to determine the volume and number distributions of the toner. Volume-average (Dv) and number-average (Dn) particle diameters of the toner were determined from the distributions.

13 channels, i.e., 2.00 to less than 2.52 μm; 2.52 to less than 3.17 μm; 3.17 to less than 4.00 μm; 4.00 to less than 5.04 μm; 5.04 to less than 6.35 μm; 6.35 to less than 8.00 μm; 8.00 to less than 10.08 μm; 10.08 to less than 12.70 μm; 12.70 to less than 16.00 μm; 16.00 to less than 20.20 μm; 20.20 to less than 25.40 μm; 25.40 to less than 32.00 μm; and 32.00 to less than 40.30 μm were used.

(b) Amount of Charge

6 g of the toner was put in a sealed metallic cylinder and blown to determine the amount of charge thereof. The toner concentration was from 4.5 to 5.5% by weight.

(c) Circularity

A flow-type particle image analyzer FPIA-2000 from SYSMEX CORPORATION can measure the average circularity. The specific measuring method includes adding 0.1 to 0.5 ml of a surfactant, preferably an alkylbenzenesulfonic acid dispersant in 100 to 150 ml of water from which impure solid materials were previously removed; adding 0.1 to 0.5 g of the toner in the mixture; dispersing the mixture including the toner with an ultrasonic disperser for 1 to 3 min to provide a dispersion liquid having a concentration of from 3,000 to 10,000 pieces/μl; and measuring the toner shape and distribution with the above-mentioned measuring device.

(d) Haze Factor

An image was produced on an OHP sheet type PPC-DX from Ricoh Company, Ltd. in a full-color copier PRETER 550 from Ricoh Company, Ltd. by the OHP mode when the fixing roller had a surface temperature of 160° C. such that the toner is developed by 1.0±0.1 mg/cm² thereon, which is modified to have a higher spring pressure of the fixer and a nip width of 1.6 times.

The haze factor of the image was measure by a direct reading haze factor computer HGM-2DP from Suga Test Instruments Co., Ltd.

The haze factor is also called cloudiness and represents the transparency of a toner. The smaller the haze factor, the higher the transparency. The colorability of a toner on an OHP sheet and an underlayer thereof improves, and the resulting image has wider color reproducibility. The haze factor is preferably not greater than 30%, and more preferably not greater than 20%.

(e) Glossiness

An image was produced on an a transfer sheet type 6000-70W from Ricoh Company, Ltd. in a full-color copier PRETER 550 from Ricoh Company, Ltd. when the fixing roller had a surface temperature of 160° C. such that the toner is developed by 1.0±0.1 mg/cm² thereon, which is modified to have a higher spring pressure of the fixer and a nip width of 1.6 times.

The glossiness of the image was measured by a gloss meter from Nippon Denshoku Industries Co., Ltd. at an incident angle of 600. The higher the glossiness, the more the gloss. Brilliant images having good color reproducibility need a glossiness of not less than 10%. Full-color copy images preferably have a glossiness of from about 10 to 30%.

(f) Pigment Dispersion Diameter in a Toner

A cross section of an ultra thin slice of a toner is photographed using a transmission electron microscope H-9000H from Hitachi, Ltd. at 100,000 magnifications. An average value of the dispersion diameters of randomly chosen 100 pigments in the photograph was determined. The dispersion diameter of a particle was an average of the longest and shortest diameters, and an aggregate was regarded as a particle.

(g) Image Density

The image density of a solid image was measured by X-Rite from X-Rite, Inc. 5 points of each solid color image were measured and an average value of the 5 points was determined for each color. An image density of not less than 1.4 is a practicable level.

(h) Image Granularity

A photo image was produced in a single color and the granularity of the image was visually evaluated.

(i) Background Fouling

Background fouling of a transfer sheet was visually evaluated.

(j) Toner Scattering

Toner contamination in a copier was visually evaluated.

In addition, as an endurance test, before and after 50,000 images of a chart having an image area of 5% were produced by modified IPSIO color 8000 from Ricoh Company, Ltd. The evaluation item (b) was performed, and (h) and (j) were performed after the test.

The properties of the toners are shown in Table 1 and evaluation results thereof are shown in Table 2.

Any toners in the Examples included finely and uniformly dispersed colorants and produced images having good image properties. The toner in the Comparative Example 1 included a pigment without a dispersant, and therefore the pigment was not well dispersed and had a large dispersion diameter. Accordingly, the toner produced images having poor image density and haze factor, and the charge stability thereof deteriorated. The toner in the Comparative Example 2 also included a pigment without a dispersant although it including a master batch pigment, and therefore the properties thereof were not satisfactory.

TABLE 1

Master batch

| | | | Pigment | |
|---|---|---|---|---|
| | | | dispersion | |
| | | Pigment | auxiliary | |
| | Pigment | dispersant | agent | Solvent |
| Ex. 1 | P.B. 15:3 | S24000sc | Not used | Water |
| Ex. 2 | P.R. 122 | S24000sc | Not used | Water |
| Ex. 3 | P.Y. 155 | S24000sc | Not used | Water |
| Ex. 4 | Printex 60 | S24000sc | Not used | Water |
| Ex. 5 | P.B. 15:3 | S24000sc | S5000 | Water |
| Ex. 6 | P.B. 15:3 | S24000sc | Not used | Ethyl |
| | | | | acetate |
| Com. Ex. 1 | P.B. 15:3 | Not used | Not used | Only |
| | | | | pigment |
| Com. Ex. 2 | P.B. 15:3 | Not used | Not used | Water |

| | Pigment Dispersion | | | | |
|---|---|---|---|---|---|
| | Dispersion | 0.7 μm or | | | |
| | diameter | more | Particle Diameter | | Average |
| | (μm) | (number %) | Dv (μm) | Dv/Dn | circularity |
| Ex. 1 | 0.45 | 4.4 | 5.3 | 1.19 | 0.964 |
| Ex. 2 | 0.38 | 4.0 | 5.1 | 1.23 | 0.978 |
| Ex. 3 | 0.41 | 4.2 | 5.0 | 1.15 | 0.973 |
| Ex. 4 | 0.22 | 2.8 | 5.5 | 1.14 | 0.985 |
| Ex. 5 | 0.38 | 3.7 | 5.2 | 1.21 | 0.969 |
| Ex. 6 | 0.42 | 4.3 | 4.9 | 1.24 | 0.965 |
| Com. Ex. 1 | 0.75 | 75.0 | 5.0 | 1.18 | 0.971 |
| Com. Ex. 2 | 0.63 | 22.3 | 5.4 | 1.22 | 0.966 |

TABLE 2

| | Glossiness | Haze factor | Image | Granulari- |
|---|---|---|---|---|
| | (%) | (%) | density | ty |
| Ex. 1 | 21 | 16 | 1.8 | ⊚ |
| Ex. 2 | 22 | 14 | 2.0 | ⊚ |
| Ex. 3 | 25 | 15 | 1.9 | ⊚ |
| Ex. 4 | 19 | — | 2.1 | ⊚ |
| Ex. 5 | 24 | 18 | 2.0 | ⊚ |
| Ex. 6 | 23 | 17 | 1.9 | ⊚ |
| Com. Ex. 1 | 17 | 35 | 1.3 | ◯ |
| Com. Ex. 2 | 16 | 28 | 1.4 | ◯ |

| | | | Background | Toner |
|---|---|---|---|---|
| | Charge Amount | | fouling | scattering |
| | | After 50,000 | After 50,000 | After 50,000 |
| | | images were | images were | images were |
| | Initial | produced | produced | produced |
| Ex. 1 | 27 | 21 | ⊚ | ⊚ |
| Ex. 2 | 24 | 18 | ⊚ | ⊚ |
| Ex. 3 | 30 | 26 | ⊚ | ⊚ |
| Ex. 4 | 29 | 17 | ⊚ | ⊚ |
| Ex. 5 | 28 | 20 | ⊚ | ⊚ |
| Ex. 6 | 26 | 19 | ⊚ | ⊚ |
| Com. Ex. 1 | 18 | 10 | Δ | Δ |
| Com. Ex. 2 | 20 | 14 | ◯ | Δ |

This document claims priority and contains subject matter related to Japanese Patent Application No. 2002-289090 filed on Oct. 1, 2002, and which is incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a binder resin comprising a urea-modified polyester resin; and
a colorant master batch comprising:
a colorant;
a resin; and
a pigment dispersant,
wherein the toner is prepared by a method comprising:
dissolving or dispersing a toner composition comprising a modified polyester resin capable of forming the urea-modified polyester resin and the colorant master batch in an organic solvent, thereby forming a liquid;
dispersing the liquid in an aqueous medium comprising resin fine particles while reacting the urea-modified polyester resin with at least one of a crosslinker and an elongation agent to provide particles; and
washing the particles after removing the organic solvent therefrom.

2. The toner of claim 1, wherein the pigment dispersant is present in an amount of 1 to 30% by weight based on total weight of the colorant.

3. The toner of claim 1, wherein the colorant master batch further comprises a pigment dispersion auxiliary agent.

4. The toner of claim 1, wherein the colorant has a number-average particle diameter of not greater than 0.5 μm, and wherein a ratio of particles of the colorant having a number-average particle diameter not less than 0.7 μm is not greater than 5% by number.

5. The toner of claim 1, wherein the toner composition further comprises an unmodified polyester resin, and wherein a weight ratio (i/ii) of the urea-modified polyester resin (i) to the unmodified polyester resin (ii) is from 5/95 to 25/75.

6. The toner of claim 1, further comprising a wax.

7. The toner of claim 1, wherein the toner has a glass transition temperature of from 40 to 70° C.

8. The toner of claim 1, wherein the toner has a volume-average particle diameter of from 4 to 8 μm, and wherein a ratio (Dv/Dn) of the volume-average particle diameter (Dv) to the number-average particle diameter (Dn) of the toner is not greater than 1.25.

9. The toner of claim 1, wherein the toner has an average circularity of from 0.94 to 1.00.

10. The toner of claim 1, wherein the resin fine particles have an average particle diameter of from 5 to 500 nm.

11. A developer comprising the toner according to claim 1.

12. An imaging forming method comprising:
charging a photoreceptor;
irradiating the photoreceptor to form an electrostatic latent image thereon;
developing the electrostatic latent image with a toner according to claim 1 to form a toner image on the photoreceptor;
transferring the toner image onto a transfer sheet; and
fixing the toner image on the transfer sheet.

13. A toner container containing the toner according to claim 1.

14. An image forming apparatus comprising:
a charger for charging a photoreceptor;
an irradiator for irradiating the photoreceptor to form an electrostatic latent image thereon;
an image developer for developing the electrostatic latent image with a toner according to claim 1 to form a toner image on the photoreceptor;
a transferer for transferring the toner image onto a transfer sheet; and
a fixer for fixing the toner image on the transfer sheet.

15. A detachable process cartridge with an image forming apparatus comprising:
a photoreceptor; and
a member selected from the group consisting of chargers, image developers and cleaners,
wherein the image developers comprise a developer comprising the toner according to claim 1.
